(19) United States
(12) Patent Application Publication
(10) Pub. No.: US 2012/0032499 A1
(43) Pub. Date: Feb. 9, 2012

(54) Safety skewer release apparatus and method

(76) Inventor: J. Leonard Ashman, Folsom, CA (US)

(21) Appl. No.: 13/135,940

(22) Filed: Jul. 18, 2011

Related U.S. Application Data
(60) Provisional application No. 61/401,224, filed on Aug. 9, 2010.

(51) Int. Cl. B62K 25/02; B23P 17/00

(52) U.S. Cl. 301/124.2; 29/402.04

(57) ABSTRACT

The present invention allows a user to mount/dismount a bicycle wheel in a single motion. An outer shell contains a single cam operated by an external lever. One feature of the cam is a detent that, when the cam is rotated to the proper position and pulled back, mates with a shoulder to effectively lock the skewer shaft in place. Upon rotation of the lever, the internal cam is pulled to the locked position where the wheel will clear impediments on a bicycle frame or fork without any additional manipulation.

This non-provisional application for patent claims priority under 35 USC 119(a) based on U.S. provisional application No. 61/401,224 filed Aug. 9, 2010.

### BRIEF DESCRIPTION

The subject of this invention relates to the bicycle industry. More specifically, the disclosed invention teaches a novel and improved wheel mounting skewer release mechanism where the improvement is a single acting internal cam that allows the user to mount or dismount the wheel without the need to adjust the skewer and advantageously locks the release lever in place greatly simplifying the wheel changing process and significantly improving rider safety. A single motion of the release lever moves both ends of the improved skewer outward so that sufficient clearance is provided to clear the front fork safety tabs. Moreover, should the release lever be inadvertently loosened, an internal spring maintains pressure on the moving parts of the release mechanism such that the wheel stays properly mounted.

### BACKGROUND OF THE INVENTION

Bicycles have existed for many years. In 1817 in its earliest incarnation, the bicycle was a simple set of two same sized in-line wheels, the front wheel steerable. The user straddled the apparatus and moved it forward with his feet. This apparatus, also known as a hobby horse, was invented by Baron von Drais to assist him in moving about his estate gardens.

In 1865 the first pedal propelled bicycle appeared, called a velocipede. Also referred to as a bone-shaker, this apparatus had pedals on the front wheel which was also used to steer. Then, about 1870 the classic high wheel apparatus, the first to be called a bicycle, appeared on the scene and enjoyed great popularity. From this point, in a fairly straight line of descendentcy, the modern bicycle has emerged. Advances in material science, chiefly metallurgy, and more recently, composite material science, have created more efficient, stronger and higher performing bicycles.

One feature that has not changed in over one hundred years is the basic mechanical configuration of a bicycle. Generally the user mounts the apparatus and applies pressure to a pair of pedals. These pedals are attached to crank arms which drive a chain. The chain receives power input from a pedal crank that has a motive force exerted upon it from a rider's legs. The force is transferred by the chain to the driven wheel by a geared cog, for example, which is in turn mechanically linked to a hub. The hub is attached to the drive wheel by means of spokes or solid inserts such as in the so-called disk wheels. In this way linear force from a rider's legs is transformed to rotational force applied to the wheel and then to the road surface.

In the case of the front wheel, no driving components exist. The front wheel simply fits into a pair of lugs on the end of the front forks. The methodology used to mount/dismount the wheel is the same, thus a discussion of either the front or the rear wheel will suffice. It is worth mentioning that there is a type of bicycle referred to as a “recumbent” that can have a front wheel drive configuration, but as those of skill in the art will recognize, the mounting methods remain the same.

Whether a front or rear wheel, and regardless of the method used to fix the wheel to the frame, lugs are used to receive the axel. Many types of lugs are in use with just as many configurations. Some are horizontal with a front opening, some horizontal with a rear opening and some are vertical, either top or bottom loaded. Regardless of the type of lug used, the method of fixing the wheel to the frame of the bicycle remains the same, thus any type of lug may be used in a discussion without consideration of a specific type. In the discussion that follows, a vertical lug with a down-facing opening is used, but the methods discussed could be used with any type of lug configuration.

From time to time the wheels must be detached from the bicycle frame, for example, to change a flat tire or to replace a worn part. There exist many contemporary methods for attaching the wheel to the bicycle frame. One method uses a solid axle threaded on both ends. Once the axle ends have been located correctly in the frame lugs, axel nuts are tightened to fix the wheel in place. A second method uses a hollow axle through which a rod, or so called skewer, is run. One end of the skewer has a lever and the other end an adjustable nut. Once the wheel is in the correct position the lever is operated which results in a clamping force to fix the wheel in place.

While these methods are functional, they suffer from a common flaw. Modern bicycles have safety features which force the user to manipulate the axel or skewer considerably in order to remove the wheel from the frame. In the case of the front wheel, a pair of safety tabs exist that are used to keep the wheel from separating from the frame if the axel or skewer becomes loose. In the case of the rear wheel, the lugs that receive the axel or skewer tend to interfere with wheel removal. In both cases, contemporary wheel mounting schemes fail to provide the needed clearance to drop away from the frame lugs without manipulation. Once the wheel is clear, maintenance can occur, but the same problems exist upon remounting of the wheel.

A second major problem with prior art methods is that the derailleur, usually located on the rear wheel, is very delicate. The derailleur is the devise that moves the chain inward or outward to select one of a plurality of cogs in order to increase or decrease speed. If the user inadvertently applies a force in the wrong place, for example, while manipulating axel nuts or the skewer nut, the alignment of the derailleur box could be adversely affected.

What would be desirable is an apparatus that eliminates the need for the user to manipulate the axel or skewer. What would be additionally desirable is an apparatus that improves the safety of a rider. The apparatus of the present invention provides an improved wheel skewer that accomplishes these goals as well as eliminating other problems related to the prior art methods discussed above by providing a single motion that moves both ends of the skewer outward at the same time yielding sufficient clearance to dismount/mount a wheel without additional manipulation.

### SUMMARY OF THE INVENTION

The present invention allows a user to mount/dismount a bicycle wheel in a single motion. An outer shell contains a single cam operated by an external lever. One feature of the cam is a detent that, when the cam is rotated to the proper position and pulled back, mates with a shoulder to effectively lock the skewer shaft in place. Upon rotation of the lever, the internal cam is pulled to the locked position where the wheel will clear impediments on a bicycle frame or fork without any additional manipulation.

For the present invention, a skewer shaft is connected to a spring loaded piston located inside a shell. A shaft connects to the piston and through the wall of the shell as well, connecting to an external lever. An internal cam is fitted about the shaft such that when the external lever is operated, the shaft turns the cam causing the shell to move laterally with respect to the piston.

The internal cam has a unique detent on its outer surface. As the lever is actuated and then pulled away from the bicycle frame, the cam is pulled back and places the detent directly over a shoulder formed by a cavity inside the shell. The detent seats on this shoulder and, since the piston and shell are spring loaded with respect to each other, the skewer shaft becomes locked at its outward-most lateral position. At this point any impediment to removing the wheel, for example safety tabs or derailleur parts, has been cleared and the rider may simply drop the wheel. In this way a single motion of the lever allows a rider to remove a wheel from a bicycle frame.

As well as the advantages discussed above, other advantages of the present invention are discussed below in conjunction with the drawings and figures attached.

### BRIEF DESCRIPTION OF THE DRAWINGS

FIG. 1: is a side sectional view of the present invention.

FIG. 2: is a top sectional view of the present invention.

FIG. 3: is a diagram showing operation of the present invention.

FIG. 4: shows operation of the apparatus of the present invention in the context of a conventional bicycle wheel.

### DETAILED DESCRIPTION OF PREFERRED EMBODIMENTS

As described briefly above, the apparatus of the present invention provides substantial improvements in the way a bicycle wheel is mounted/dismounted to/from a bicycle frame. The improvement is based upon a unique skewer release mechanism.

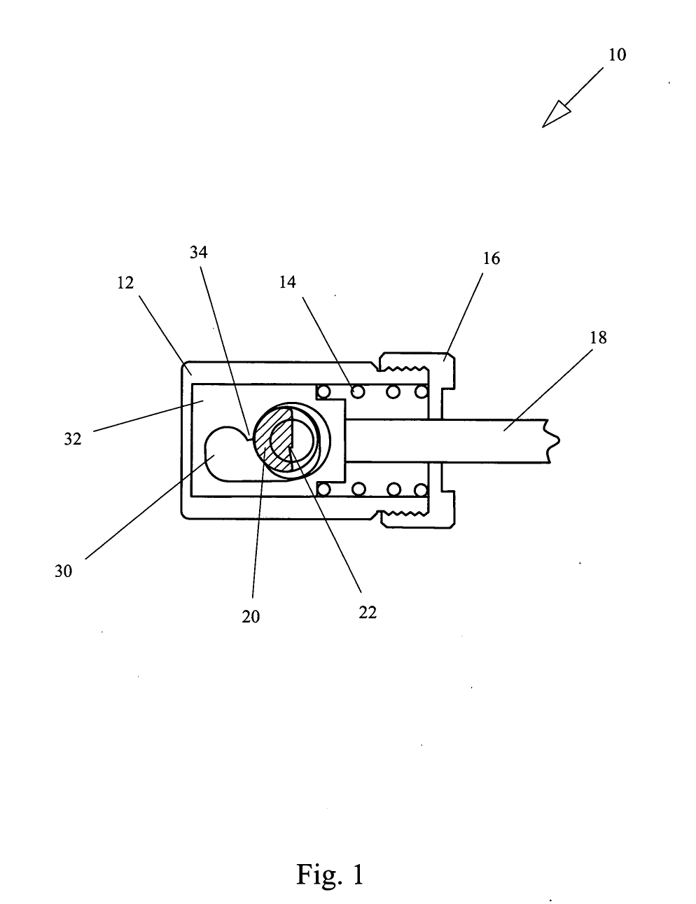

Looking at FIG. 1, the apparatus 10 of the present invention is shown in a side sectional view. A shell 12 contains a piston 32 with a cam receiving cavity 30, a detent shoulder 34, a cam 20 with a detent 22, a compression spring 14 and an end cap 16. A contemporary skewer shaft 18 is an integral part of the piston 32 but is otherwise identical to and operates in the same manner as other contemporary skewers, thus the opposite end is not shown or discussed to aid in clarity.

In a preferred embodiment, the shell is made from aluminum and has an outer diameter of approximately 0.75 inch and an inner diameter of approximately 0.5 inch. Those of skill in the art will recognize that the shell could be made form a different material and have dimensions different than those given without departing from the spirit of the invention, thus the scope of the invention is limited only be the claims. The piston, cam and skewer shaft of the present invention are made from steel but could be made from other materials without departing from the spirit of the invention.

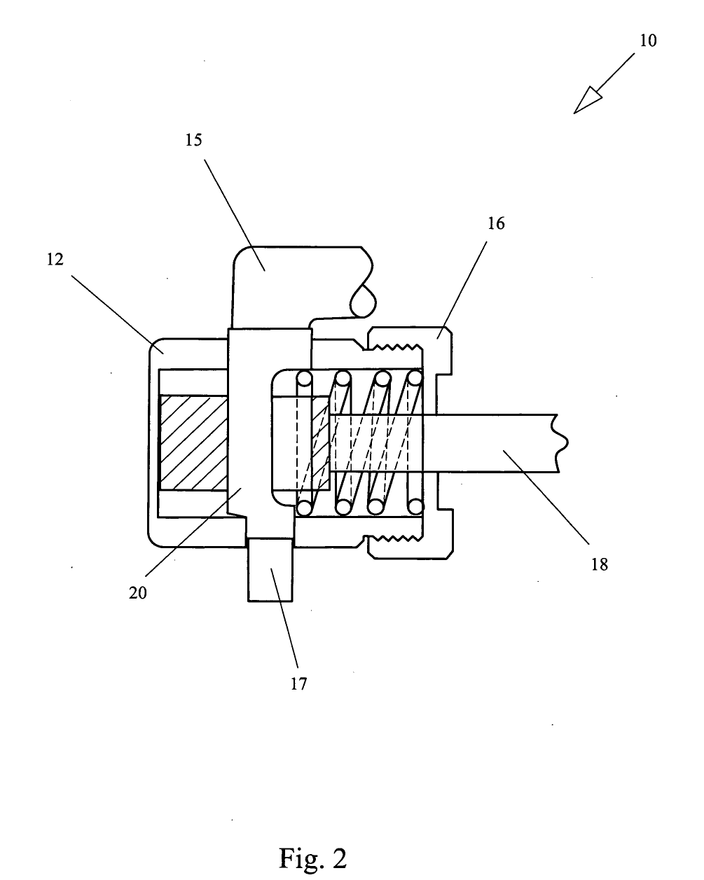

Looking at FIG. 2, a top section view 10 of the apparatus of the present invention is shown. In this view shell 12, end cap 16 and skewer shaft 18 are the same items as in FIG. 1. Note that skewer shaft 18 is connected to the piston [32 of FIG. 1]. A lever 15 is connected to shaft 17. The shaft 17 has cam 20 as an integral part. The cam is configured such that one side is flat so that when rotated approximately 90 degrees from the vertical it can pass beneath a shoulder in a cavity of the piston. The combined shaft 17 and cam 20 pass through shell 12 and the piston 32 such that any motion of the lever 15 results in a lateral motion of the shell 12.

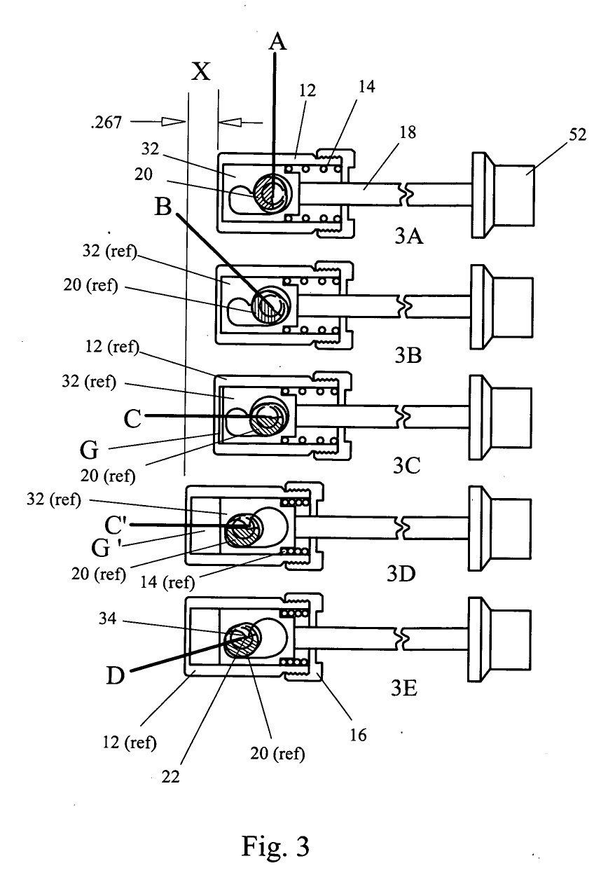

Operation of the present invention is shown in FIG. 3. Beginning with 3A, the release lever [item 15 in FIG. 2] of the apparatus is shown in position A, the closed, or in-use position. In this state, spring 14 pushes sliding piston 32 against the inner surface of the shell 12 and the action of cam 20 against the sliding piston 32 generates the clamping force required to ensure that the wheel is firmly attached to the bicycle frame. The clamping force is transmitted via skewer shaft 18 pulling cap 52 against the lugs of a bicycle frame. Neither the lugs nor the frame are shown for clarity, however, those of skill in the art will recognize that these components operate in the conventional manner.

Moving to 3B, the user has begun the dismounting process by moving the release lever to the B position. Doing so releases the clamping force of cam 20 against piston 32. In 3C the release lever is horizontal. At this time the release lever is at position C and cam 20 has rotated to the point where no more force is exerted against piston 32, leaving the shell 12 free to move over the piston. Since the piston 32 is stationary, a gap G begins to form as the shell 12 moves.

Looking now at 3D, the user has applied a pulling force on the release lever at position C′ causing the spring 14 to compress. This pulling force moves cam 20 into the vacant cam receiving cavity [30 of FIG. 1] creating gap G′ between the sliding shell 12 and the surface of the piston 32. The user then moves the release lever to position D, as shown in 3E, at which time the detent 22 in cam 20 mates with shoulder 34 on piston 32 effectively locking the cam 20 against the shoulder of the piston 32. At this time the shell 12 has moved 0.26 inches with respect to the piston 32, providing more than enough clearance to remove the wheel without interfering with the safety tabs. The combination of the pulling action and the locking cam are unique and a significant improvement over the prior art.

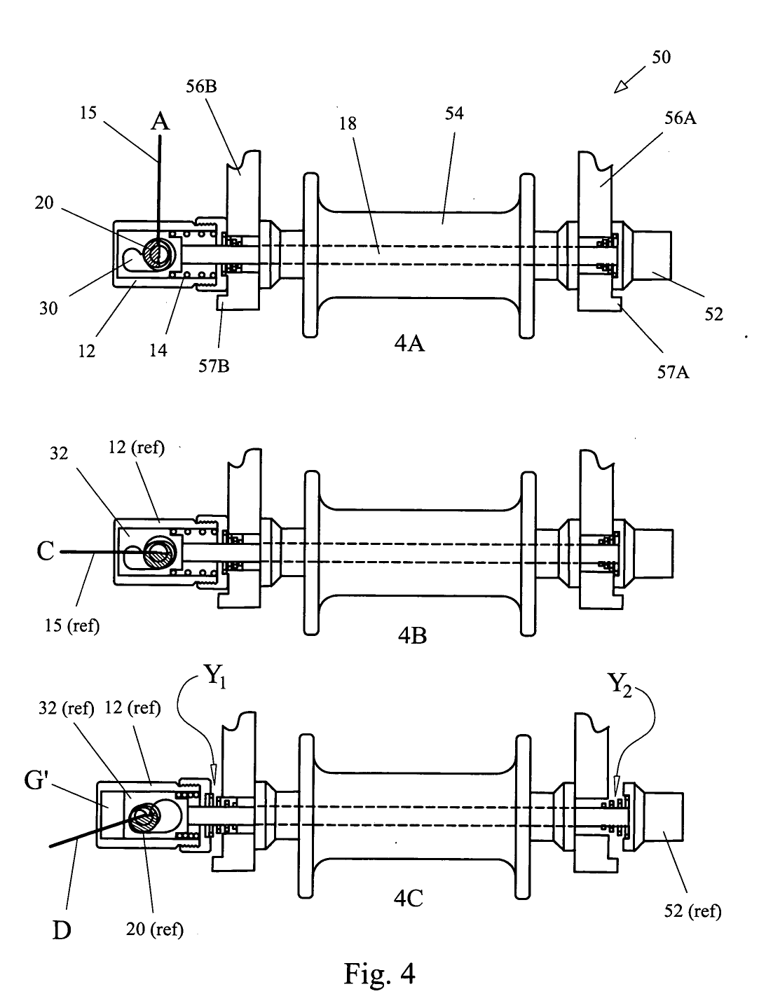

While FIG. 3 is an accurate description of the operation of the apparatus of the present invention, it is useful to show how the operation relates in the context of a conventional bicycle wheel. FIG. 4A shows the apparatus of the present invention in the normal, in-use state. A contemporary bicycle hub 54 is mounted between two wheel lugs 56A and 56B. Each of the wheel lugs 56A and 56B has a safety tab 57A and 57B respectively associated with it. A skewer shaft 18 has a cap 52 threaded on it at one end, and the apparatus of the present invention attached at the opposite end.

As was described in association with FIG. 3, lever 15 is at position A when in use. In this position cam 20 has applied a captive pulling force such that spring 14 is decompressed and shell 12 and related parts described above press on lug 56B while cap 52 exerts a force on lug 56A. At this point the cam receiving cavity 30 is empty. However, even if lever 15 is accidentally moved towards position C, as shown in FIG. 4B, the wheel will remain mounted due to the force of spring 14 against sliding piston 32. This is a significant safety improvement over contemporary skewer release mechanisms.

To dismount the wheel, lever 15 is moved first to position C as shown in FIG. 4B. At this time sliding piston 32 is still pressed against shell 12 by spring 14 as detailed just above. The user then pulls lever 15 in such a way as to cause the flat side of cam 20 to move into cam receiving cavity 30. At this point gap G′ has formed as the result of the compression of spring 14. Two approximately equal gaps Y1 and Y2 are formed. These gaps measure approximately 0.13 of an inch and are sufficient to allow the wheel to clear safety tabs 57A and 57B shown in FIG. 4A. The user then moves lever 15 to position D where the detent in cam 20, described in detail above in conjunction with FIGS. 1 and 3, seats on the shoulder 34 of the cavity 30 [22 of FIG. 3E]. This locks the sliding piston 32 in place with respect to shell 12, allowing the user to simply drop the wheel away from the bicycle frame.

The mounting process is the reverse of the dismounting process. The user simply places the wheel in the lugs of the bicycle frame and operates the release lever until it is in position A. Once the user has moved the lever 15 toward the in-use position A, the cam detent 22 unseats from the shoulder of the piston and, since the shell 12 and piston 32 are spring loaded with respect to each other, the gap G′ closes and the skewer shaft 18 applies the requisite pulling orce to lock the wheel in place.

One advantage of the present invention is that sufficient movement of the skewer ends is provided such that no additional manipulation of the skewer nut is required in order to mount or dismount the wheel.

A second advantage of the present invention is a significant increase in rider safety. Unlike conventional skewer release methods, if the lever is inadvertently loosened, the apparatus of the present invention maintains sufficient force on the various skewer components to keep it in place.

A third advantage of the present invention is that it employs a locking cam mechanism that, in combination with a pulling action by the user, fixes the skewer ends in place for ease of dismounting and remounting of a bicycle wheel.

A fourth advantage of the present invention is that may be used on either the front or rear wheel of a bicycle. Moreover, due to the positive locking action of the cam and the horizontal travel distance, the invention may be used with all types of bicycles that use a standard skewer mechanism, including both road and mountain bicycles.

What is claimed is:

1. An improved safety bicycle wheel skewer release mechanism, the improvement comprising:
a cylindrical shell having an outer diameter and an inner diameter closed on one end and open at the opposite end, said opposite end being threaded on said outer diameter;
a threaded end cap having threads suitable for mating with said threads on said outer diameter of said cylindrical shell and having a hole through the center suitable for passing a skewer shaft;
a piston sized to pass freely inside said inner diameter of said cylindrical shell, said piston having two adjoined cavities with a first larger cavity oriented toward said open end of said cylindrical shell and a second smaller cavity oriented toward said closed end of said cylindrical shell wherein said first cavity and said second cavity overlap forming a single third cavity such that a shoulder is formed at the junction of said overlap of said first and said second cavities and wherein said piston is connected to said skewer shaft;
a cam, said cam passing through the approximate center of said cylindrical shell having a lever fixably attached to the rotational axis and further having a detent suitable for seating against said shoulder of said third cavity, and;
a spring sized to freely pass inside said inner diameter of said cylindrical shell, said spring passing over said skewer shaft and being compressed between said piston and said end cap such that when said lever is operated in a first closed direction said cam operates against the surface of said first cavity causing said spring to decompress and said skewer shaft to move in a first horizontal direction thereby applying a clamping force suitable for attaching a bicycle wheel to the frame lugs of a bicycle frame and when said lever is operated in a second open direction said cam operates against said surface of said first cavity causing said spring to compress and said skewer shaft to move in a second horizontal direction thereby removing said clamping force, and when said lever is operated further in said second open direction accompanied by a pulling force on said lever causing said cam to enter said second cavity said detent on said cam seats on said shoulder of said third cavity creating a first gap on a first side of said bicycle frame and a second approximately equal gap on a second side of said bicycle frame suitable for removing a bicycle wheel from said frame lugs of said bicycle frame.

2. The cylindrical shell of claim 1 wherein the outer diameter of said cylindrical shell is approximately 0.75 inch and the inner diameter of said cylindrical shell is approximately 0.5 inch.

3. The approximately equal gaps of claim 1 wherein said gaps measure approximately 0.13 inch.

4. A method for removing/attaching a wheel to a bicycle frame, the method comprising:
operating a lever connected to a cam in a first open direction, said operation describing an approximately 90 degree arc counterclockwise thereby releasing a clamping force exerted upon the lugs of a bicycle frame;
pulling said lever in an outward direction causing two approximately equal gaps to form on opposing sides of a bicycle wheel;
operating said lever further in a counterclockwise direction approximately 10 degrees;
releasing said pulling force on said lever while maintaining said lever position such that a detent on said cam seats upon a shoulder in a piston cavity;
removing said bicycle wheel from said lugs of said bicycle frame;
performing a maintenance task upon said bicycle wheel;
replacing said bicycle wheel in said lugs of said bicycle frame, and;
operating said lever in a clockwise direction approximately 100 degrees thereby causing a clamping force to be applied to said lugs of said bicycle frame.
